(19) United States
(12) Patent Application Publication
(10) Pub. No.: US 2011/0246874 A1
(43) Pub. Date: Oct. 6, 2011

(54) METHOD AND APPARATUS FOR RECEIVING A USER COMMENT RELATING TO A CONTENT SEGMENT AND PROVIDING FOR OUTPUT OF A NEW CONTENT SEGMENT BASED ON AN ASSOCIATION STRUCTURE

(75) Inventors: Sailesh Kumar Sathish, Tampere (FI); Arto Juhani Lehtiniemi, Lempaala (FI)

(73) Assignee: Nokia Corporation

(21) Appl. No.: 12/750,032

(22) Filed: Mar. 30, 2010

(51) Int. Cl. G06F 17/27

(52) U.S. Cl. 715/256

(57) ABSTRACT

An apparatus providing for output of a new content segment may include a contextual characteristic determiner for determining one or more contextual characteristics. The apparatus may use the contextual characteristics to output a content segment, which a user may then comment on. The apparatus may use a token extractor to extract tokens from the comment and thereby associate the tokens, the contextual characteristics, and the content segment with an association structure using an association structure generator. Accordingly, the apparatus may output of a new content segment based on the association structure in instances in which the association structure is applicable.

### TECHNOLOGICAL FIELD

Embodiments of the present invention relate generally to outputting content segments and, more particularly, relate to an apparatus, method and a computer program product for receiving a user comment on a content segment and providing for output of a new content segment based on an association structure.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

One of the technologies which is becoming more popular is that of location based services. In this regard, some technologies may provide users of properly equipped mobile terminals with content which is specific to the present location of the user, or other contextual information. Thus, for example, the user may be provided with weather information relating to the user's present location. In some cases the content may be displayed on the home screen of the device. Further, in some cases the user may be provided with information such as Uniform Resource Locators (URLs) for web resources which relate to one or both of the user's interests and the user's present location. Thus, content may be provided to the user automatically. However, the content may not always be of interest to the user when using existing methods of selecting content.

### BRIEF SUMMARY

A method, apparatus and computer program product are therefore provided that may provide for output of a content segment and then a new content segment based on an association structure created after receiving a user comment. The new content segment, which may for example comprise a URL link, may be of greater interest to the user due to the association structure being based on the user comment.

In an example embodiment, an improved apparatus comprises at least one processor and at least one memory including computer program code, the at least one memory and the computer program code configured to, with the processor, cause the apparatus to at least perform determining one or more contextual characteristics, providing for output of a content segment based at least in part on the contextual characteristics, receiving a user comment relating to the content segment, extracting one or more tokens from the user comment, associating the tokens, the contextual characteristics, and the content segment with an association structure, and providing for output of a new content segment based on the association structure in instances in which the association structure is applicable.

The apparatus may also be configured to provide for selection of one or more known tokens extracted from the user comment. The apparatus may further be configured to provide for comparison of one or more current contextual characteristics to the contextual characteristics to determine if the association structure is applicable. Also, the apparatus may provide for associating the association structure with one or more related content segments. Further, the apparatus may be configured to suggest a rule template for the association structure. Additionally, the apparatus may be configured to update a user profile based on the association structure. The apparatus may also be configured to provide for associating the association structure with one or more related user profiles.

In an additional example embodiment a method comprises determining one or more contextual characteristics, providing for output of a content segment based at least in part on the contextual characteristics, receiving a user comment relating to the content segment, extracting one or more tokens from the user comment, associating the tokens, the contextual characteristics, and the content segment with an association structure, and providing for output of a new content segment based on the association structure in instances in which the association structure is applicable.

In some embodiments the method may also comprise providing for selection of one or more known tokens extracted from the user comment. The method may further provide for comparison of one or more current contextual characteristics to the contextual characteristics to determine if the association structure is applicable. Additionally, the method may include providing for associating the association structure with one or more related content segments. Further, the method may comprise suggesting a rule template for the association structure. The method may also update a user profile based on the association structure. Additionally, the method may comprise providing for associating the association structure with one or more related user profiles.

In a further example embodiment a computer program product comprises at least one computer-readable storage medium having computer-executable program code portions stored therein, the computer-executable program code portions comprising program code instructions for determining one or more contextual characteristics, program code instructions providing for output of a content segment based at least in part on the contextual characteristics, program code instructions for receiving a user comment relating to the content segment, program code instructions for extracting one or more tokens from the user comment, program code instructions for associating the tokens, the contextual characteristics, and the content segment with an association structure, and program code instructions providing for output of a new content segment based on the association structure in instances in which the association structure is applicable.

In some embodiments the computer program product may further comprise program code instructions for selection of one or more known tokens extracted from the user comment. Additionally, the computer program product may comprise program code instructions providing for comparison of one or more current contextual characteristics to the contextual characteristics to determine if the association structure is applicable. Further, the computer program product may comprise program code instructions providing for associating the association structure with one or more related content segments. Also, the computer program product may include program code instructions for suggesting a rule template for the association structure. The computer program product may additionally comprise program code instructions providing for associating the association structure with one or more related user profiles.

Accordingly, embodiments of the present invention may provide for improved outputting of a new content segment based on an association structure in instances in which the association structure is applicable.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus providing for output of a new content segment based on an association structure according to an example embodiment of the present invention; and

FIG. 3 illustrates a flowchart according to an example method providing for output of a new content segment based on an association structure in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

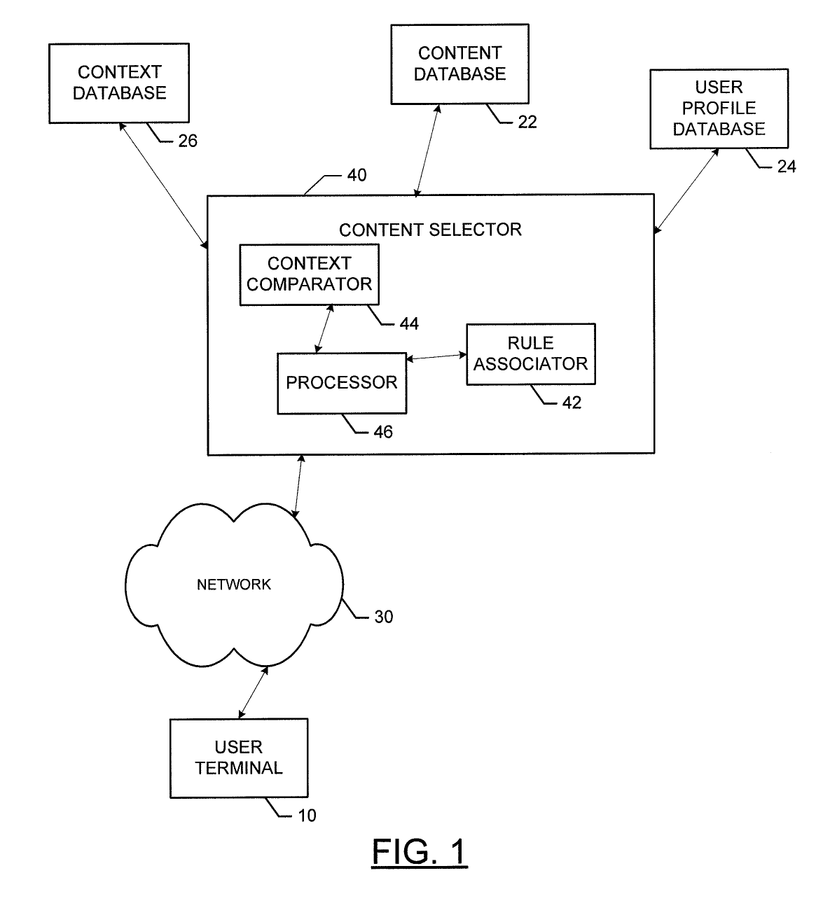

As indicated above, embodiments of the present invention may be employed in methods, apparatuses and computer program products providing for output of a new content segment based on an association structure. In this regard, for example, FIG. 1 illustrates a block diagram of a system that may benefit from embodiments of the present invention. It should be understood, however, that the system as illustrated and hereinafter described is merely illustrative of one system that may benefit from embodiments of the present invention and, therefore, should not be taken to limit the scope of embodiments of the present invention.

As shown in FIG. 1, an embodiment of a system in accordance with an example embodiment of the present invention may include a user terminal 10. The user terminal 10 may be any of multiple types of fixed or mobile communication and/or computing devices such as, for example, portable digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, and other types of voice and text communications systems, which employ embodiments of the present invention.

The user terminal 10 may be configured to output one or more content segments, such as URL links or other content such as pictures, data, audio, or video. In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal 10 and/or the other devices may be enabled to communicate with each other, for example, according to numerous communication protocols including Hypertext Transfer Protocol (HTTP) and/or the like, to thereby carry out various communication or other functions of the mobile terminal 10 and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The system may further comprise a content selector 40 which may be in communication with the user terminal 10 either directly, or through the network 30. As will be described in detail below, the content selector 40 may be configured to select a content segment and transmit it to the user terminal 10. Specifically, the content selector 40 may be configured to receive one or more contextual characteristics from the user terminal 10, and select a content segment for the user terminal based at least in part on the one or more contextual characteristics. As will be described below, the content selector 40 may additionally be configured to select a new content segment for the user terminal 10 based on an association structure. The content selector 40 may include a rule associator 42 which is configured to associate an association structure to one or both of related content segments and related user profiles. Content and user profile information may be respectively stored in a content database 22 and a user profile database 24, which may be in communication with the content selector 40 either directly, or through the network 30. The content selector 40 may further comprise a context comparator 44 which is configured to compare current contextual characteristics with contextual characteristics which are previously received to determine if the association structure is applicable. The content segments may be stored in a context database 26 which may be in communication with the content selector 40 either directly, or through the network 30.

The content selector 40 may further comprise a processor 46. The processor 46 may be embodied as, include or otherwise control the rule associator 42 and/or the context comparator 44. The processor 46 may be embodied in a number of different ways. For example, the processor 46 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an example embodiment, the processor 46 may be configured to execute instructions stored in a memory device or otherwise accessible to the processor 46. Alternatively or additionally, the processor 46 may be configured to execute hard coded functionality. As such, whether configured by hardware or software methods, or by a combination thereof, the processor 46 may represent an entity (for example, physically embodied in circuitry) capable of performing operations according to embodiments of the present invention while configured accordingly. Thus, for example, when the processor 46 is embodied as an ASIC, FPGA or the like, the processor 46 may be specifically configured hardware for conducting the operations described herein. Alternatively, as another example, when the processor 46 is embodied as an executor of software instructions, the instructions may specifically configure the processor 46 to perform the algorithms and/or operations described herein when the instructions are executed. However, in some cases, the processor 46 may be a processor of a specific device (for example, a mobile terminal or network device such as a server) adapted for employing embodiments of the present invention by further configuration of the processor 46 by instructions for performing the algorithms and/or operations described herein. The processor 46 may include, among other things, a clock, an arithmetic logic unit (ALU) and logic gates configured to support operation of the processor 46.

In some embodiments the content selector 40 may be a server, server bank or other computer or other computing device or node configured to select content. The content selector 40 may have any number of functions or associations with various services. As such, for example, the content selector 40 may be a platform such as a dedicated server (or server bank), or the content selector may be a backend server associated with one or more other functions or services. Thus, the content selector 40 may potentially select a variety of different content segments. In some embodiments the content selector 40 may select and distribute commercial and/or non-commercial content. Accordingly, the operations performed by the content selector 40 may or may not comprise processing payment in exchange for distributing the content segments. In some embodiments payment may be processed by a separate device. Further, although the content selector 40 is herein generally described as a server, in some embodiments the content selector may be embodied as a portion of the user terminal 10, such an internal module therein. Further, in some embodiments some of the functionality of the user terminal 10 may instead be conducted by the content selector 40.

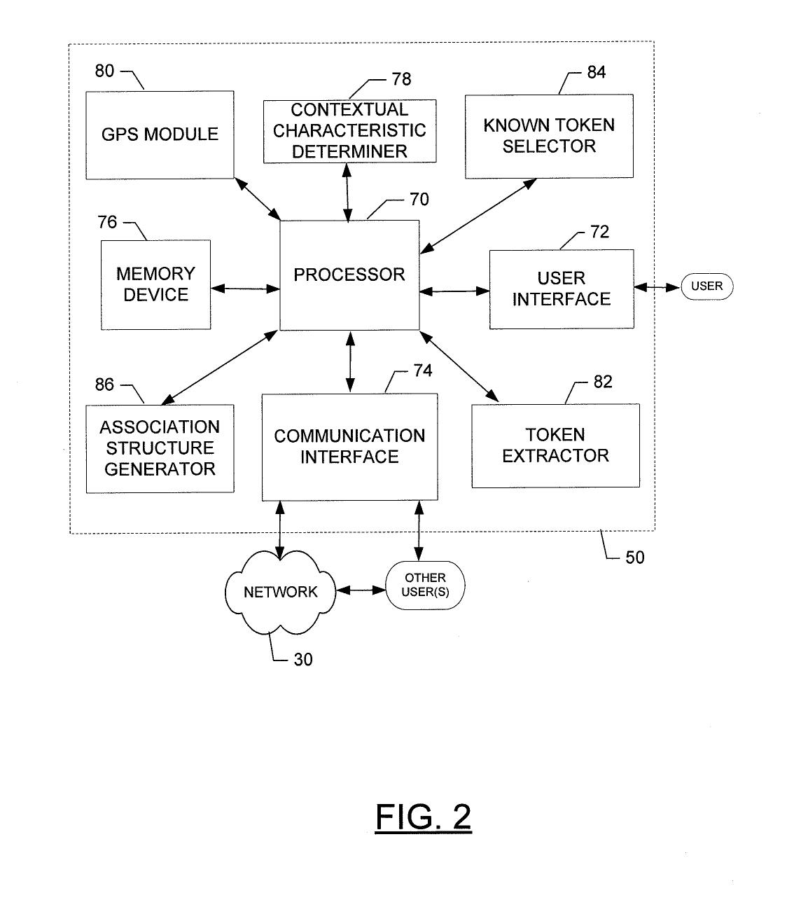

In an example embodiment, an apparatus 50 is provided that may be employed by devices performing example embodiments of the present invention. The apparatus 50 may be embodied, for example, as any device hosting, including, controlling or otherwise comprising the user terminal 10. However, embodiments may also be embodied on a plurality of other devices such as for example where instances of the apparatus 50 may be embodied on the network 30 and/or the content selector 40. As such, the apparatus 50 of FIG. 2 is merely an example and may include more, or in some cases less, than the components shown in FIG. 2. Specifically, in some embodiments the apparatus 50 may include some or all of the illustrated components of the content selector 40 when embodied as the user terminal 10, and vice versa.

With further regard to FIG. 2, the apparatus 50 is configured to output a content segment, for example by displaying a content segment selected by the content selector 40 based at least in part on one or more contextual characteristics. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases or storage locations that store information and/or media content.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (for example, a mobile terminal or network device such as a server) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms.

In some embodiments the apparatus 50 may include a contextual characteristic determiner 78, which may determine one or more contextual characteristics. Contextual characteristics may include the present time, location, activity, etc. of the user and/or the apparatus. The processor 70 may be embodied as, include or otherwise control the contextual characteristic determiner 78. Thus, for example, the contextual characteristic determiner 78 may determine that the user is presently at home, or outside walking. Information relating to the location of the user may, for example, be provided by a GPS module 80, though location information may additionally or alternatively be provided through other means such as triangulation using cell phone towers in some embodiments. Thus, the apparatus 50 may determine one or more contextual characteristics.

The one or more contextual characteristics, which as described above may be determined by the contextual characteristic determiner 78, may be provided by the apparatus 50 to another device for selection of a content segment. For example, the apparatus may use the communication interface 74 to transmit contextual characteristics to the content selector 40 through the network 30. The content selector 40 may thereby select one or more content segments based on the contextual characteristics, and send the content segments back to the apparatus 50. In some embodiments the content selector 40 may select the content segments from the content database 24.

One or more content segments may thereby be received by the apparatus 50, for example through the communication interface 74. However, in other embodiments the apparatus 50 may select the content segments. Regardless of which device selects the content segments, the apparatus 50 may display or otherwise output the content segments, for example using the user interface 72. After the apparatus 50 outputs a content segment, the apparatus may additionally receive a user comment relating to the content segment which may, for example, be received through the user interface 72. The apparatus may thereafter parse the comment to extract one or more tokens from the content using a token extractor 82. The processor 70 may be embodied as, include or otherwise control the token extractor 82. The tokens may include words in the comment which are deemed by the token extractor 82 to be of higher significance than the remaining words. For example, the token extractor 82 may remove words from the comment such as “a”, “an”, or “the”, which are common or otherwise deemed to be of little significance. Thus, the logic in the token extractor 82 may seek to extract the most important words in the form of tokens.

Additionally, in some embodiments the apparatus 50 may further comprise a known token selector 84. The processor 70 may be embodied as, include or otherwise control the known token selector 84. The known token selector 84 may compare the tokens extracted from the comment by the token extractor 82 to known tokens, which may be stored internally, for example in the memory device 76, or stored externally and accessible through the communication interface 74. Thus, the known token selector 84 may allow the user to select one more known tokens extracted from the user comment which are related to or otherwise associated with the tokens extracted from the user comment. Thereby, the apparatus 50 may provide for selection of known tokens which have known meanings.

The apparatus 50 may thereby create an association structure using an association structure generator 86. The processor 70 may be embodied as, include or otherwise control the association structure generator 86. The association structure generator 86 may associate the tokens, the contextual characteristics and the content segment with the association structure. When known tokens are selected using the known token selector 84, the association structure generator 86 may also associate the known tokens with the association structure. The association structure creates a link between the tokens, contextual characteristics and the content segment, which, as will be described below, may be used to select new content segments.

In some embodiments the association structure generator 86 may further suggest a rule template for selecting the new content segments. For example, the association structure generator 86 may record the time at which the comment is made and the location of the apparatus 50 at the time of the comment (determined, for example, using the GPS module 80), and combine this information with the content segment which was commented on to create a rule template. Thus, by way of example, the apparatus 50 may suggest a rule such as “When it is after 10 PM and the user is near Helsinki, Finland, provide the user with a content segment relating to pizza.” Such a rule may be suggested, for example, when the apparatus had previously provided the user with a content segment relating to a nearby seafood restaurant due to the user's profile indicating that he likes seafood, but for which the user commented that he would prefer pizza at this time of night when he is in the area. Further, the user may be provided with the opportunity to edit the rule to more exactly fit his or her preferences. Thus, in some embodiments the association structure generator 86 may create an association structure which links tokens, contextual characteristics and the content segment, but in some embodiments the association structure generator may additionally or alternatively create an association structure which includes a more specific rule relating to the tokens, contextual characteristics and the content segment.

The apparatus 50 may use the association structure to update the user profile, which may be stored internally, such as in the memory device 76, or in some embodiments externally. The apparatus 50 may also provide the association structure to the content selector 40, for purposes of selecting new content segments in the future, either for the present user or for other users as will be described below. The content selector 40 may thereby use the rule associator 42 to associate the association structure with one or both of related content segments and related user profiles which may be respectively stored, for example, in the content database 24 and the user profile database 26. In doing so, the rule associator 42 may determine whether the association structure is applicable to each content segment in the content database 24 and each user profile in the user profile database 26. For example, the rule associator 42 may examine each content segment included in the content database 22 and associate the association structure with any related content segments which have, for example, a similar semantic structure which describes what the content segments relate to. Similarly, the rule associator 42 may examine each user profile included in the user profile database 24 and associate the association structure with any related user profiles which have, for example, similar interests which may be recorded in tag sets and tag rules.

In some embodiments the rule associator 42 may further calculate a content scalar metric which indicates a relative difference between the content segment which was commented on and the related content segments. This may, for example, be used to determine the weight which is accorded to the association structure when the content selector 40 is selecting a new content segment, and/or to determine whether or not the association structure is at all applicable. Similarly, the rule associator 42 may further calculate a user profile scalar metric which indicates a relative difference between the user profile of the user which commented on the content segment and the related user profiles. This may, for example, be used to determine the weight which is accorded to the association structure when the content selector 40 is selecting a new content segment for users having related user profiles, and/or to determine whether or not the association structure is at all applicable. Thus, in some instances the association structure created from the recommendation of one user may be applied to new content segments produced for other users have related user profiles.

Further, the contextual characteristics for which the content selector 40 originally selected the content segment and which have the association structure associated therewith may be stored in the context database 26. Thus, the content selector 40 may use the context comparator 44 to compare one or more current contextual characteristics which are later provided by the apparatus 50 to the contextual characteristics which were originally provided by the apparatus and commented on by the user to determine if the association structure is applicable. Accordingly, in some embodiments the content selector 40 may only apply the association structure while selecting a new content segment in instances in which the contextual characteristics are determined to be related to the contextual characteristics of the content segment which was commented on by the user and with which the association structure is associated. After the content selector 40 has selected a new content segment, which may be based on the association structure in instances in which the association structure is applicable, the content selector may provide the new content segment to the apparatus 50. The apparatus 50 may thereby output the content segment, such as through the user interface 72. Accordingly, the user may be provided with content which may be of greater interest to the user by taking into account the user's comment when appropriate.

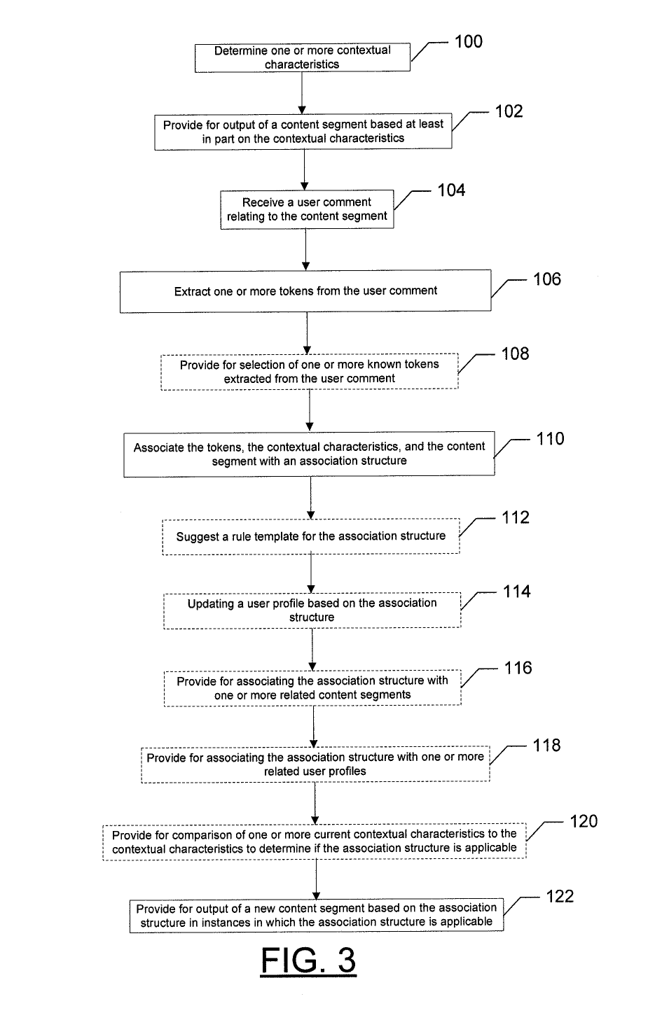

In terms of methods associated with embodiments of the present invention, the above-described apparatus 50 or other embodiments of apparatuses may be employed. In this regard, FIG. 3 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method comprises determining one or more contextual characteristics at operation 100. The method may further comprise providing for output of a content segment based at least in part on the contextual characteristics at operation 102. Further, the method may comprise receiving a user comment relating to the content segment at operation 104. Additionally, the method may include extracting one or more tokens from the user comment at operation 106. In some embodiments the method may further comprise providing for selection of one or more known tokens extracted from the user comment at operation 108.

As illustrated at operation 110, the method further comprises associating the tokens, the contextual characteristics, and the content segment with an association structure. In some embodiments the method may further comprise suggesting a rule template for the association structure at operation 112. The method may also comprise updating a user profile based on the association structure at operation 114. Further, the method may include providing for associating the association structure with one or more related content segments at operation 116 and/or associating the association structure with one or more related user profiles at operation 118. In some embodiments the method may further comprise providing for comparison of one or more current contextual characteristics to the contextual characteristics to determine if the association structure is applicable at operation 120. Also, the method may comprise providing for output of a new content segment based on the association structure in instances in which the association structure is applicable at operation 122.

In an example embodiment, an apparatus for performing the method of FIG. 3 and other methods described above may comprise a processor (for example, the processor 70) configured to perform some or each of the operations (100-122) described above. The processor may, for example, be configured to perform the operations (100-122) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-122 may comprise, for example, the processor 70, the user interface 72, the communication interface 74, the memory device 76, the contextual characteristic determiner 78, the GPS module 80, the token extractor 82, the known token selector 84, and the association structure generator 86, and/or an algorithm executed by the processor for processing information as described above. However, the above-described portions of the apparatus 50 as they relate to the operations of the method illustrated in FIG. 3 are merely examples, and it should be understood that various other embodiments may be possible.

In some embodiments the operation 100 of determining one or more contextual characteristics may be conducted by means, such as the contextual characteristic determiner 78, the GPS module 80 and/or the processor 70. Further, providing for output of a content segment based at least in part on the contextual characteristics at operation 102 may be conducted by means such as the user interface 72 and/or the processor 70. In some embodiments the content segment may be selected by the content selector 40 and provided to the apparatus 50 through the communication interface 74. With regard to the operation 104 of receiving a user comment relating to the content segment, this operation may be conducted by means such as the user interface 72 and/or the processor 70. Further, the operation 106 of extracting one or more tokens from the user comment may be conducted by means such as the token extractor 82 and/or the processor 70. Also, selection of one or more known tokens extracted from the user comment at operation 108 may be conducted by means such as the known token selector 84, the token extractor 82 and/or the processor 70.

Further, the operation 110 of associating the tokens, the contextual characteristics, and the content segment with an association structure and the operation 112 of suggesting a rule template for the association structure may be conducted by means such as the association structure generator 86 and/or the processor 70. Additionally, the operation 114 of updating a user profile based on the association structure may be conducted by means such as the processor 70, either individually or in conjunction with the memory device 76. Also, the operation 116 of providing for associating the association structure with one or more related content segments and the operation 118 of providing for associating the association structure with one or more related user profiles may be conducted by means such as the communication interface 74 and/or the processor 70. Accordingly, by way of example, the apparatus 50 may provide for transmission of the association structure to the content selector 40, which may then analyze the content database 22 and the user profile database 24.

Further, the operation 120 of providing for comparison of one or more current contextual characteristics to the contextual characteristics to determine if the association structure is applicable may be conducted by means such as the contextual characteristic determiner 78, GPS module 80, and/or the processor 70, which may determine the contextual characteristics and current contextual characteristics, and the communication interface 74. Accordingly, comparison of the current contextual characteristics and the contextual characteristics which were originally commented on may be conducted, for example, by the content selector 40 and/or the processor 46, though in other embodiments this may be conducted by the apparatus itself. Additionally, the operation 120 of providing for output of a new content segment based on the association structure in instances in which the association structure is applicable may be conducted by means such as the user interface 72 and/or the processor 70 to thereby provide the user with the new content segment, which may be of interest to the user.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to at least perform:
determining one or more contextual characteristics;
providing for output of a content segment based at least in part on the contextual characteristics;
receiving a user comment relating to the content segment;
extracting one or more tokens from the user comment;
associating the tokens, the contextual characteristics, and the content segment with an association structure; and
providing for output of a new content segment based on the association structure in instances in which the association structure is applicable.

2. The apparatus of claim 1, further comprising providing for selection of one or more known tokens extracted from the user comment.

3. The apparatus of claim 1, further comprising providing for comparison of one or more current contextual characteristics to the contextual characteristics to determine if the association structure is applicable.

4. The apparatus of claim 1, further comprising providing for associating the association structure with one or more related content segments.

5. The apparatus of claim 1, further comprising suggesting a rule template for the association structure.

6. The apparatus of claim 1, further comprising updating a user profile based on the association structure.

7. The apparatus of claim 1, further comprising providing for associating the association structure with one or more related user profiles.

8. A method comprising:
determining one or more contextual characteristics;
providing for output of a content segment based at least in part on the contextual characteristics;
receiving a user comment relating to the content segment;
extracting one or more tokens from the user comment;
associating the tokens, the contextual characteristics, and the content segment with an association structure; and
providing for output of a new content segment based on the association structure in instances in which the association structure is applicable.

9. The method of claim 8, further comprising providing for selection of one or more known tokens extracted from the user comment.

10. The method of claim 8, further comprising providing for comparison of one or more current contextual characteristics to the contextual characteristics to determine if the association structure is applicable.

11. The method of claim 8, further comprising providing for associating the association structure with one or more related content segments.

12. The method of claim 8, further comprising suggesting a rule template for the association structure.

13. The method of claim 8, further comprising updating a user profile based on the association structure.

14. The method of claim 8, further comprising providing for associating the association structure with one or more related user profiles.

15. A computer program product comprising at least one computer-readable storage medium having computer-executable program code portions stored therein, the computer-executable program code portions comprising:
program code instructions for determining one or more contextual characteristics;
program code instructions providing for output of a content segment based at least in part on the contextual characteristics;
program code instructions for receiving a user comment relating to the content segment;
program code instructions for extracting one or more tokens from the user comment;
program code instructions for associating the tokens, the contextual characteristics, and the content segment with an association structure; and
program code instructions providing for output of a new content segment based on the association structure in instances in which the association structure is applicable.

16. The computer program product of claim 15, further comprising program code instructions providing for selection of one or more known tokens extracted from the user comment.

17. The computer program product of claim 15, further comprising program code instructions providing for comparison of one or more current contextual characteristics to the contextual characteristics to determine if the association structure is applicable.

18. The computer program product of claim 15, further comprising program code instructions providing for associating the association structure with one or more related content segments.

19. The computer program product of claim 15, further comprising program code instructions for suggesting a rule template for the association structure.

20. The computer program product of claim 15, further comprising program code instructions providing for associating the association structure with one or more related user profiles.
